(19) United States
(12) Patent Application Publication
(10) Pub. No.: US 2017/0330482 A1
(43) Pub. Date: Nov. 16, 2017

(54) USER-CONTROLLED VIDEO LANGUAGE LEARNING TOOL

(71) Applicants: Matthew J. Vendryes, Davis, CA (US); Ruoan Ji, Davis, CA (US); John Bukowinski, Lafayette, CA (US)

(72) Inventors: Matthew J. Vendryes, Davis, CA (US); Ruoan Ji, Davis, CA (US); John Bukowinski, Lafayette, CA (US)

(21) Appl. No.: 15/153,632

(22) Filed: May 12, 2016

(51) Int. Cl. G09B 19/06; G09B 5/06; G06F 17/27; G06F 17/28; G10L 21/10; G10L 15/26

(52) U.S. Cl. CPC G09B 19/06; G10L 21/10; G10L 15/26; G06F 17/2735; G06F 17/2836; G09B 5/065

(57) ABSTRACT

A user views a video for learning a target language. The video is displayed with a caption that the user may interact with to select a phrase of interest to the user. A translation of the phrase is determined and a definition retrieved for the phrase. The translation is provided in the user's native language, and the definition may be provided in the target language. In addition, occurrences of the phrase may be identified in the remainder of the video, and a marker indicated in a timeline of the video to indicate when in the video the phrase appears, permitting the user to easily view additional contexts of the selected phrase. The user may also hide and display various interface elements to reduce reliance on the translation provided by the language learning system.

### BACKGROUND

This invention relates generally to language learning, and more particularly to facilitating learning through a video interface.

The use of videos in language education is a known technique for facilitating language learning. The use of videos for language learning has advantages over more traditional language learning tools, such as textbooks. For example, videos allow a user to connect target-language words and phrases with actions that are familiar to the user that are displayed in the video.

However, such videos are limited in that the displayed caption does not allow a user to learn the meaning of specific words or phrases that are of interest to the user. For example, the text in traditional language learning videos will translate entire sentences or multiple sentences of the spoken audio. Because the caption does not translate on a word-by-word or phrase-by-phrase basis, such captions prevent users from learning the meaning of individual words or phrases.

While recently-developed video language learning tools allow users to view definitions of individual words or phrases (as opposed to entire sentences), such tools still suffer from the lack of user control. The captions do not allow a user to select the specific words or phrases the user desires to be translated, based on the user's specific and personal learning needs.

### SUMMARY

A language learning system presents a language learning video to a user of the language learning system. The video includes audio in a target language that the user wishes to learn. The video is presented with a caption that transcribes the audio. The caption may be presented with a caption including the audio of the language learning video transcribed to the target language. This initial caption may thus include words in the target language that the user wants to learn. Attaching the captioned audio in the target language to the audio of the target language may help in linking the captioned words and phrases to the audio of how those words and phrases are spoken.

The user may also select a translation phrase including a set of words from the caption. The translation phrase is received by the language learning system, and the language learning system identifies a translation of the translation phrase and a dictionary definition of the phrase. The translation is provided in the user's native language, while the dictionary definition may be determined in the target language. In this way, a user is self-directed in selecting which portions of a caption are relevant to the user, and retrieve a translation for those portions. This may be particularly helpful to provide an intermediate language learner with the ability to link known words and phrases via the dictionary to selected phrases.

After selection of a translation phrase, the translation phrase may also be added to a user-defined list of phases. When a user selects a phrase, either from the caption or from the user-defined list of phrases, the language learning system may identify where the phrase occurs in the video being viewed by the user, and display a time marking on a timeline of the video identifying when the phrase occurs. This permits the user to easily view the different portions of the video that include the phrase, so that the user can view different uses of the phrase in differing contexts.

Using the language learning system, a user may learn another languages in a manner that is tailored to individual learning needs. The language learning system is thereby highly interactive and allows each user to control the type and amount of information that is displayed.

### BRIEF DESCRIPTION OF THE DRAWINGS

FIGS. 1A & 1B illustrate example user interfaces in which a user may view videos for language learning.

FIG. 2 shows an overview of an environment for a language learning system that provides videos to a user.

FIG. 3 shows an example flowchart of a method for providing video learning.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A language learning system provides language translation and definition to a user viewing videos of a target language. The language learning system receives selected phrases from the user and provides a translation of the phrase in addition to a definition of the phrase for the user. The translation may be provided in the user's language (i.e., a native language), while the definition may be provided in the user's target language. This permits the intermediate language learner to view additional information in context for the phrase, and use the target language for further learning of the definition of the phrase. The different places (e.g., particular times) in the video at which the phrase occurs are also identified and indicated to the user, so that the user may view the phrase of interest in the different contexts in which it occurs.

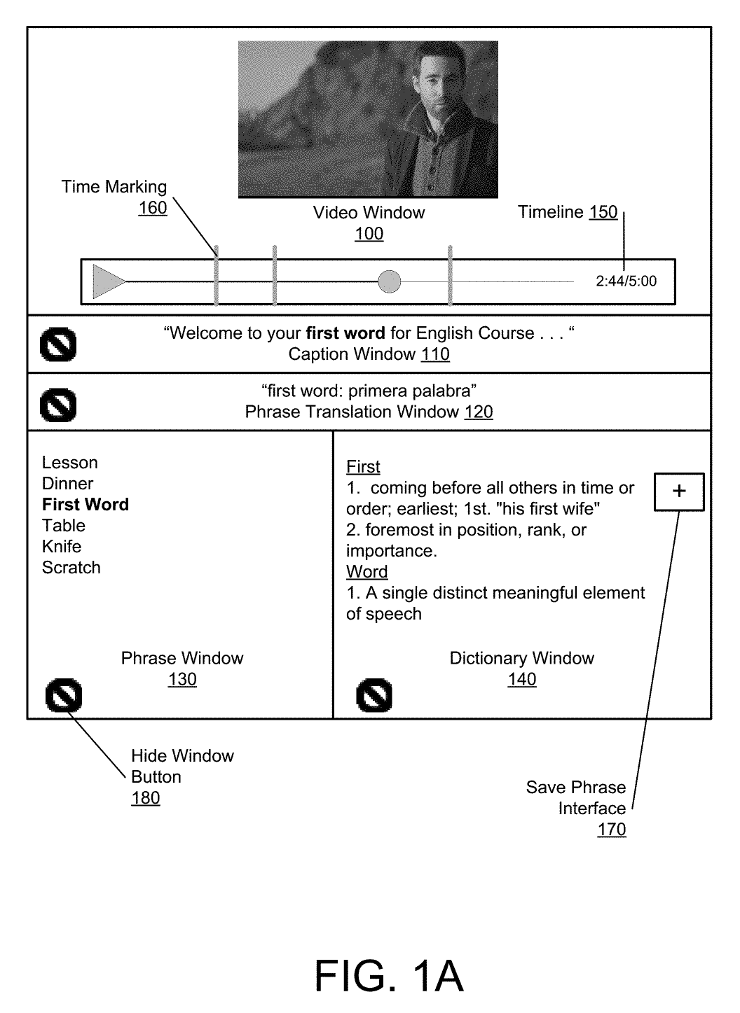

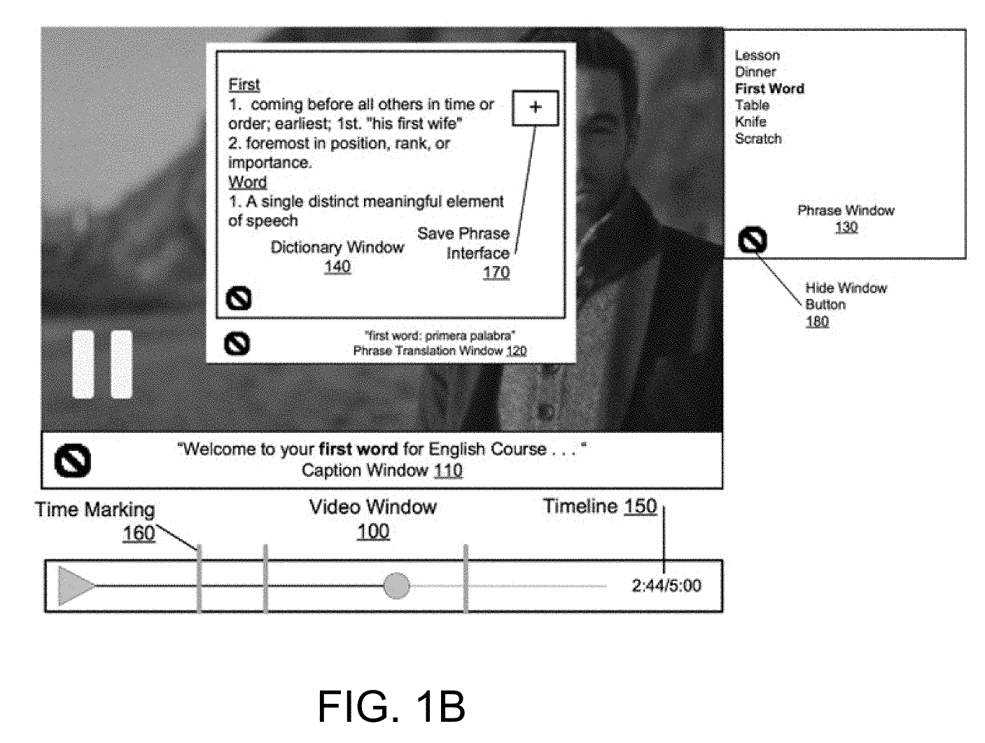

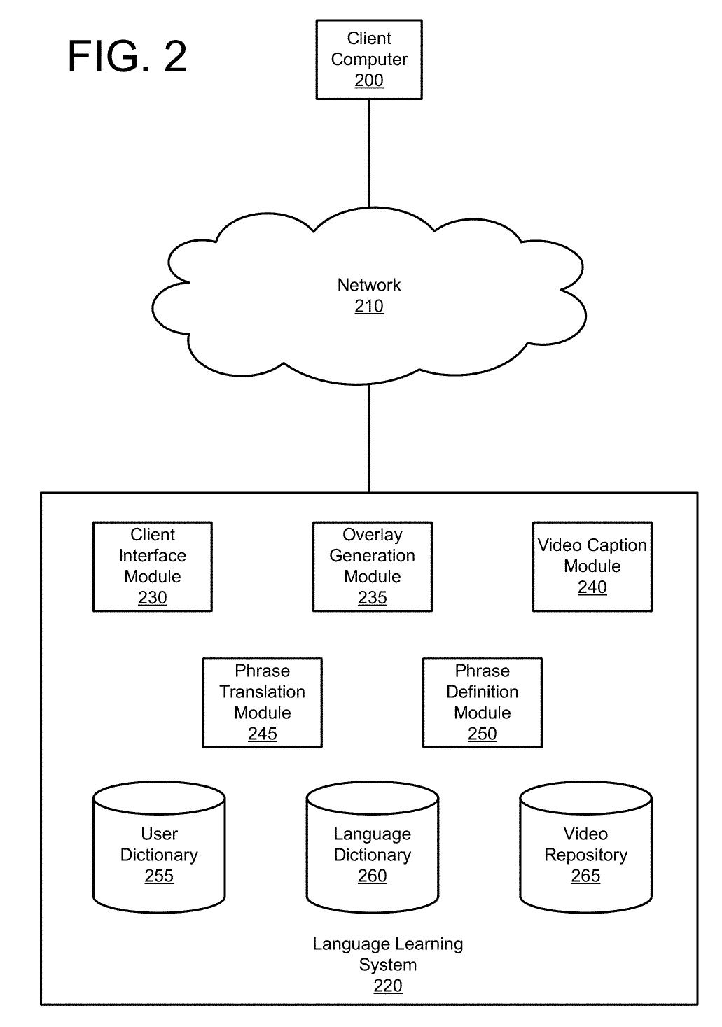

FIGS. 1A & 1B illustrate example user interfaces in which a user may view videos for language learning. In this example, a user wishes to learn English (the target language), and the user's native language is Spanish (i.e., the language in which the user wishes to receive translations of the target language). The example interface of FIG. 1A may be displayed by the client computer 200 in conjunction with language learning system 220, which are shown in FIG. 2. The user interface allows for substantial user control over the type and amount of information shown to the user and permits the user to select phrases for additional translation and definition to the user.

The example user interface shown in FIG. 1A includes a video window 100, a caption window 110, a phrase translation window 120, a phrase window 130, and a dictionary window 140.

The video window 100 displays a video to the with audio in the target language and a timeline 150 with time markings 160 indicating locations or positions in the video in which user-selected words and phrases occur. Various additional windows may be optionally displayed to the user. In this example, the user interface includes an optionally displayed caption window 110 that displays caption text in the target language, an optionally displayed translation window 120 with caption text in the user's native language, an optionally displayed dictionary window 140 with dictionary definitions, and an optionally displayed phrase window 130 displaying phrases of interest to the user.

The various optionally displayed windows may be hidden or displayed based on the user's choice and depending on the user's personal learning needs. For example, a beginner user may desire to display all optionally displayed windows, whereas an advanced user may desire to hide all optionally displayed windows. Viewing the window with caption text in the target language facilitates user comprehension because the user is able to read the target language, rather than rely solely on auditory comprehension. Viewing the translation window 120 in the user's native language further facilitates user comprehension because the user is able to read the translation, rather than rely solely on his or her ability to translate. Viewing the dictionary window 140 with dictionary definitions provides the user with definitions of phrases selected by the user, while the phrase window 130 permits the user to view phrases of interest to the user, which may include those that pose difficulty for the user. In one embodiment of the invention, the window for the user-generated list provides a means for the user to view all occurrences of a word or phrase from the list in the video. An advanced user may desire to hide all optionally displayed windows in order to improve auditory comprehension and test his or her ability to recall definitions. By hiding optionally displayed windows, the user prevents itself from relying on the captions and dictionary functions for comprehending the video.

The video displayed in the video window 100 may be a language lesson, movie, television show, lecture, news video, or other video with audio. An accompanying caption window 110 displays accompanying captions or subtitles or text that transcribes the audio in the video. The captions may be part of the video, may be added to the video using automatic caption generating technology, such as AMARA or YOUTUBE Captioner, or may be added to the video using manual means, and may be generated by the video caption module 240 at discussed below. The captions may be displayed in the target language—the language that the user is trying to learn. The captions may display individual lines of the audio of the video, and may “roll” with the displayed video, such that the word associated with the current audio is synchronized to the center of the caption window 110. The video contains a timeline 150 that tracks the time progression of the video.

The user may interact with the caption window 110 to select a phrase of interest to the user. In this example, the user has selected “first word” as a phrase of interest to the user. The phrase may include one or more words of the caption for the video. In one embodiment, the user may select words or phrases of interest by clicking and dragging a cursor over the desired text. In another embodiment, the user may select words or phrases by moving the cursor to hover over the desired text. In still another embodiment, the user may select words or phrases of interest by verbal identification.

After selecting a phrase, the phrase may be translated and a dictionary definition of the phrase may be retrieved. The translation of the phrase may be displayed in the phrase translation window 120. In this example, “first word” in the target language (English) is translated to “primera palabra” in the user's native language (Spanish).

A dictionary window 140 displays dictionary definitions of words or phrases selected by the user. In the preferred embodiment, the invention is connected to one or more dictionary application program interfaces (API), which supply the relevant dictionary definitions. In another embodiment, the video language learning tool of the present invention may have a built-in dictionary. For example, the dictionary window may display the part of speech, definitions, other parts of speech, other definitions, synonyms, example sentences to show use, and antonyms. The dictionary window may display definitions in a target language or the native language, or both. In one embodiment, the definition is displayed in the target language, to encourage the user to continue to learn additional terms and phrases in the target language and understand how the translation displayed in the phrase translation window 120 may match the description in the dictionary window 140. The phrase translation window 120 may provide additional translation to the user to determine the meaning of the phrase in the user's native language.

A phrase window 130 maintains a set of phrases of interest to the user. The user may interact with the save phrase interface 170 displayed as a part of the dictionary window 140 to add a selected phrase to the set of phrases. The set of phrases displayed in the phrase window 130 represent those phrases that a user may wish to continue to learn or study, such as those that the user would like to revisit. For intermediate or expert language learners, the user selection of phrases permits the user to decide which phrases from a video are the most interesting to the user. Thus, the user-generated list may contain the words and phrases that pose difficulty to the user. For example, the user may add words and phrases to the user-generated list that the user knows he or she needs to review. The user may also select a phrase from the phrase window 130 as an alternative to selecting the phrase from the caption window 110.

When a user selects a phrase, either from the caption window 110 or from the phrase window 130, in addition to the dictionary window 140, the language learning system may provide occurrences of the selected word or phrase in the video. For example, upon selection of a word or phrase, the timeline 150 of the video will show time markings 160 along the timeline 150 to illustrate when in the video the phrase occurs. The user may then click on any time marking 160 to begin playback of the video at the corresponding occurrence of the selected phrase. As each occurrence may provide the phrase in a different context, the user may use the time markings 160 to quickly view such various contexts for the phrase.

In some embodiments, the user may start or participate in a crowdsourcing conversation thread that relates to a word or phrase from the video. For example, the crowdsourcing conversation thread includes discussion from various users about the word or phrase at issue. The discussion may provide users with more insight about the meaning and use of the word or phrase, including meanings and uses that are culture-specific or colloquial. In these embodiments, the video language learning system provides users with a means to start or participate in a conversation thread once a word or phrase is saved to the user-generated list.

FIG. 1B shows another example user interface. In this example, the dictionary window may be displayed as an overlay to the video. When the user interacts with the caption window 110 to select a phrase, the video pauses and the dictionary window 140 is displayed with the dictionary definition. In addition to the dictionary window 140, the phrase translation window 120 may also be displayed to the user as an overlay on the video. When the user is done viewing these overlay windows, the user may close them to continue viewing the video or select a time marking to view other occurrences of the phrase. In this example, the user-selected phrases may be displayed in the phrase window 130 beside the video window as shown.

FIG. 2 shows an overview of an environment for a language learning system 220 that provides videos to a user. A client computer 200 is connected to a language learning system 220 via a network 210. The example user interfaces shown in FIGS. 1A & 1B may be shown to the user on a client computer 200 in conjunction with the language learning system 220. The language learning system 220 coordinates the presentation of video and language translation to the client computer 200. While the environment shown in FIG. 2 illustrates a language learning system 220 and a single client computer 200, in practice many additional elements may be included. For example, many more client computers 200 may be provided, and various components shown here as a portion of language learning system 220 may be disposed in separate computing system. These components may include the video repository 265, phrase translation module 245, phrase definition module 250, and so forth. That is, the language learning system 220 may provide front-end interfaces to the client computer 200, but request services, such as streaming video and translation from other systems.

The client computer 200 is a computing device operated by the user to view language videos and present an interface to the user. The client computer 200 may be any suitable computing device that may also receive input from the user and communicate with the language learning system 220 via the network 210. Example types of client computer 200 include laptop and desktop computers, tablet computers, personal data assistants (PDAs), smartphones, and so forth.

The network 210 provides a communications channel between the language learning system 220 and the client computer 200. The network 210 may be any combination of wired and wireless communication systems.

The language learning system 220 coordinates with the client computer 200 to provide language learning services to users of the client computer 200, for example to provide the video and language translation displayed in FIG. 1. The language learning system 220 includes various modules and data stores for generating language translation for the user. These modules include a client interface module 230, an overlay generation module 235, a video caption module 240, a phrase translation module 245, and a phrase definition module 250.

The client interface module 230 provides video and translation information to the client computer 200 and receives requests from the client computer 200 from user input. The client interface module 230 requests services from various other modules of the language learning system 220 based on the received requests. For example, when a user requests a video, the client interface module 230 retrieves a requested video from a video repository 265 and begins playback of the video to the client computer 200. The video repository 265 is shown here as a part of the language learning system 220, though in other examples the video repository 265 is a separate system from the language learning system 220. The client interface module 230 also requests caption information from the video caption module 240 to display the caption with the video at the client computer 200. The video caption module 240 may retrieve caption information pre-stored with the video, or may generate caption information based on the video and its audio. The caption may also be provided from a manual transcription of the video.

When a user selects a phrase, either from the caption or from a user list of phrases, the client interface module 230 retrieves a translation from the phrase translation module 245 and a definition from the phrase definition module 250 for the phrase. In addition, the overlay generation module 235 may determine where the phrase occurs in the video and provide a set of occurrences and the time of the occurrences in the video. The client interface module 230 provides the translation, definition, and occurrences to the client computer 200 for display to the user. The client interface module 230 may also coordinate the storage of the user's selected phrases to a user dictionary 255.

To translate a phrase, the phrase translation module 245 may apply computer modeling or trained natural-language systems to determine the translation between the target and the native language. In one example, the phrase translation module requests the translation from a third-party system via an application programming interface (API). The phrase translation module 245 may also retrieve known translation terms from a language dictionary 260.

The phrase definition module 250 determines a definition for the phrase selected by the user. The phrase may include one or more words, which may or may not correspond to a definition for the phrase as a whole. The phrase definition module 250 looks up the phrase in the language dictionary 260 to determine if the phrase is in the language dictionary 260. When the phrase is not in the language dictionary, the phrase definition module 250 separates each word in the phrase and looks up each word in the language dictionary 260. The individual words may be normalized or trimmed to assist in identifying a definition. For example, suffixes to words may be removed, and verbs may be normalized to the infinitive form prior to look-up in the language dictionary 260. Trailing spaces and characters that denote plural objects (i.e., the “s” character in English) may be removed as well. The definition for a phrase (or individual word) from the language dictionary 260 may provide the spelling, pronunciation, and meaning of the phrase, along with any additional data about the phrase. While the language dictionary 260 is shown in FIG. 2 as a part of the language learning system 220, in other examples the phrase definition module 250 accesses an external dictionary and queries the external dictionary for the definition of the phrase and its constituent parts.

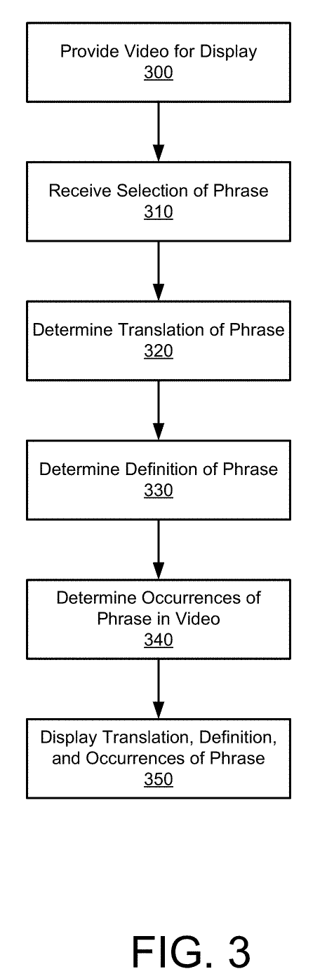

FIG. 3 shows an example flowchart of a method for providing video learning. This method may be performed by the language learning system 220. When a user requests to view a video, the video is provided 300 and begins playback to the user at a client computer. As the user views the video, the video may also be displayed with a caption, and the user may select a phrase, which is received 310 by the language learning system 220. The selection may be from the caption in which the user views the video, or may be from a user-selected set of phrases of interest to the user. Next, the language learning system determines 320 a translation of the phrase, determines 330 a definition of the phrase, and determines occurrences of the phrase in the video 340. Each of these may be sent for display 350 to the user in the interface with the video. The definition and translation of the phrase may be displayed in separate portions that may be optionally hidden by the user. In addition, the occurrences of the phrase may be displayed in time markers in a timeline of the video.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for displaying language translation for a video, comprising:
displaying a video having audio in a target language;
displaying a caption in the target language, the caption transcribing the audio of the video;
receiving a user selection of a phrase in the caption, the phrase including one or more words;
determining a translation of the phrase into a native language; and
displaying the translation of the phrase to the user with the video and the caption.

2. The method of claim 1, further comprising:
determining a definition of the phrase in the target language; and
displaying the definition with the translation in the native language.

3. The method of claim 2, wherein determining the definition comprises determining whether there is a definition of the phrase as a whole; and when there is no definition of the phrase as a whole, determining a definition for each of the one or more words included in the phrase.

4. The method of claim 3, wherein determining a definition for each of the one or more words comprises removing suffixes for the one or more words.

5. The method of claim 1, further comprising identifying occurrences of the phrase in the video and displaying the occurrences as markers in a timeline of the video.

6. The method of claim 1, further comprising adding the phase to a set of user-selected phrases.

7. The method of claim 6, further comprising displaying the set of user-selected phrases to the user with the video.

8. The method of claim 6, further comprising receiving a selection of another phrase from the user-selected phrases and displaying a translation of the other phrase and displaying timeline of the other phrase.
